(19) United States
(12) Patent Application Publication
(10) Pub. No.: US 2017/0374704 A1
(43) Pub. Date: Dec. 28, 2017

(54) IDENTIFICATION OF A SHARED EVOLVED PACKET CORE IN A NEUTRAL HOST NETWORK

(71) Applicant: QUALCOMM Incorporated, San Diego, CA (US)

(72) Inventors: Manu SHARMA, Sunnyvale, CA (US); Rajat PRAKASH, San Diego, CA (US)

(21) Appl. No.: 15/633,573

(22) Filed: Jun. 26, 2017

Related U.S. Application Data
(60) Provisional application No. 62/355,297, filed on Jun. 27, 2016.

(51) Int. Cl. H04W 76/02; H04W 84/02; H04W 88/06; H04W 36/00; H04W 72/12; H04B 1/707; H04B 7/04; H04B 7/0413; H04B 7/26; H04L 5/00; H04B 7/06

(52) U.S. Cl. CPC H04W 76/026; H04W 72/1215; H04W 84/02; H04W 88/06; H04W 36/0022; H04B 7/0613; H04B 7/043; H04B 7/0413; H04B 7/2643; H04L 5/0012; H04B 1/707; H04L 5/005; H04L 5/0025

(57) ABSTRACT

A plurality of neutral host network (NHN) deployments may share a common evolved packet core (EPC). When a plurality of NHNs share a common EPC, continuity and mobility may be facilitated for a user equipment (UE) when the UE moves between NHNs (e.g., because the NHNs share a common EPC). Accordingly, a UE may perform a tracking area update (TAU) procedure when moving between NHNs that share a common EPC. However, a UE may need to discover whether two NHNs share a common EPC in order to perform a TAU procedure. If the UE discovers that, when moving between a first NHN and a second NHN, the NHNs do not sure a common EPC, the UE may perform an attach procedure.

### CROSS-REFERENCE TO RELATED APPLICATION(S)

This application claims the benefit of U.S. Provisional Application Ser. No. 62/355,297, entitled “IDENTIFICATION OF A SHARED EVOLVED PACKET CORE IN A NEUTRAL HOME NETWORK” and filed on Jun. 27, 2016, which is expressly incorporated by reference herein in its entirety.

### BACKGROUND

### Field

The present disclosure relates generally to communication systems, and more particularly, to a neutral host network that may provide an identifier indicating whether an evolved packet core is shared or dedicated.

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In wireless communications system, a neutral host network (NHN) may provide a wireless network with connectivity (e.g., internet connectivity) servicing user equipment (UE). The NHN may provide scalable network deployments to service UEs from a plurality service providers of a plurality of mobile networks. Such network deployments of an NHN may be self-contained. An NHN may operate according to one or more wireless standards, such as LTE, LTE-Unlicensed (LTE-U), LTE-Advanced (LTE-A), fifth generation (5G) new radio (NR), Wi-Fi, and/or other radio access technologies.

The MulteFire Alliance may specify an NHN architecture based on 3GPP Evolved Packet System (EPS) architecture. This architecture may allow self-contained deployment of NHNs independently by venues and enterprises with relatively minimal interworking with mobile network operators (MNOs).

In various aspects, an NHN deployment may provide a network identity to a UE in order to facilitate discovery of connectivity (e.g., internet service) by the UE. The network identity of the NHN may be assigned by a central organization or may be selected by the deployment (e.g., random selection).

In some aspects, the NHN architecture may assume that each NHN is associated with a separate NHN evolved packet core (EPC), and therefore internet protocol (IP) mobility for packet data network (PDN) connections as a UE moves between NHNs may be absent. The lack of mobility may cause a UE to perform a new attach procedure (e.g., network attach procedure for initial attachment) when the UE moves from a first NHN to a second NHN.

In some aspects, a plurality of NHN deployments may share a common EPC. When a plurality of NHNs share a common EPC, IP continuity and mobility may be facilitated for a UE when the UE moves between NHNs (e.g., because the NHNs share a common EPC). Accordingly, a UE may perform a tracking area update (TAU) procedure when moving between NHNs that share a common EPC. However, a UE may need to discover whether two NHNs share a common EPC in order to perform a TAU procedure. If the UE discovers that, when moving between a first NHN and a second NHN, the NHNs do not sure a common EPC, the UE may perform an attach procedure (e.g., because IP mobility is impractical between NHNs that do not share a common EPC).

In an aspect of the disclosure, a first method, a first computer-readable medium, and a first apparatus are provided. The first apparatus may determine whether an EPC is associated with a plurality of NHNs, including the first NHN. The first apparatus may transmit an identifier. The identifier may be associated with at least one of the first NHN and the EPC. In an aspect, the identifier indicates whether the EPC is associated with the plurality of NHNs, including the first NHN. In an aspect, the identifier includes a first value when the EPC is associated with the plurality of NHNs, and the identifier includes a second value when the EPC is associated with the first NHN and unassociated with the plurality of NHNs. In an aspect, the first value is located in a first portion of the identifier. In an aspect, when the identifier includes the first value, EPC information associated with the EPC is located in a second portion of the identifier, and NHN information associated with the first NHN is located in a third portion of the identifier. In an aspect, when the identifier includes the second value, NHN information associated with the first NHN occupies a remaining portion of the identifier following the second value. In an aspect, the identifier implicitly indicates whether the EPC is associated with the plurality of NHNs based on whether EPC information associated with the EPC is included in the identifier. In an aspect, the identifier implicitly indicates that the EPC is associated with the plurality of NHNs, including the first NHN, when the EPC information associated with the EPC is included in the identifier.

In an aspect of the disclosure, a second method, a second computer-readable medium, and a second apparatus are provided. The second apparatus may receive, from a first network, a first identifier associated with a first NHN and an EPC, and the first identifier indicates whether the EPC is associated with a plurality of NHNs. The second apparatus may determine, based on the first identifier, whether the EPC is associated with the plurality of NHNs, including the first NHN. In an aspect, the first identifier includes a first value when the EPC is associated with the plurality of NHNs, and the first identifier includes a second value when the EPC is associated with the first NHN and unassociated with the plurality of NHNs. In an aspect, the first value or the second value is located in a first portion of the first identifier. In an aspect, when the first identifier includes the first value, EPC information associated with the EPC is located in a second portion of the identifier, and first NHN information associated with the first NHN is located in a third portion of the identifier. In an aspect, when the first identifier includes the second value, first NHN information associated with the first NHN occupies a remaining portion of the first identifier following the second value. In an aspect, the first identifier implicitly indicates whether the EPC is associated with the plurality of NHNs, including the first NHN, based on whether EPC information associated with the EPC is included in the first identifier. In an aspect, the first identifier implicitly indicates that the EPC is associated with the plurality of NHNs, including the first NHN, when the EPC information associated with the EPC is included in the first identifier. In an aspect, the second apparatus may receive, from a second network, a second identifier including second NHN information associated with a second NHN, and the second apparatus may determine, based on the second identifier, whether the second NHN is associated with the EPC when the EPC is associated with the plurality of NHNs. In an aspect, the second apparatus may perform a TAU procedure associated with the second NHN when the EPC is associated with the plurality of NHNs, including the first NHN and the second NHN. In an aspect, the second apparatus may perform an attach procedure associated with the second NHN when the second NHN is unassociated with the EPC.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a DL frame structure, DL channels within the DL frame structure, an UL frame structure, and UL channels within the UL frame structure, respectively.

FIG. 3 is a diagram illustrating an example of a base station and user equipment (UE) in an access network.

FIG. 4A is a diagram illustrating a wireless communications system.

FIG. 4B is a diagram of an identifier.

FIG. 5 is a flowchart of a method of wireless communication.

FIG. 6 is a flowchart of a method of wireless communication.

FIG. 7 is a conceptual data flow diagram illustrating the data flow between different means/components in an exemplary apparatus.

FIG. 8 is a diagram illustrating an example of a hardware implementation for an apparatus employing a processing system.

FIG. 9 is a conceptual data flow diagram illustrating the data flow between different means/components in an exemplary apparatus.

FIG. 10 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

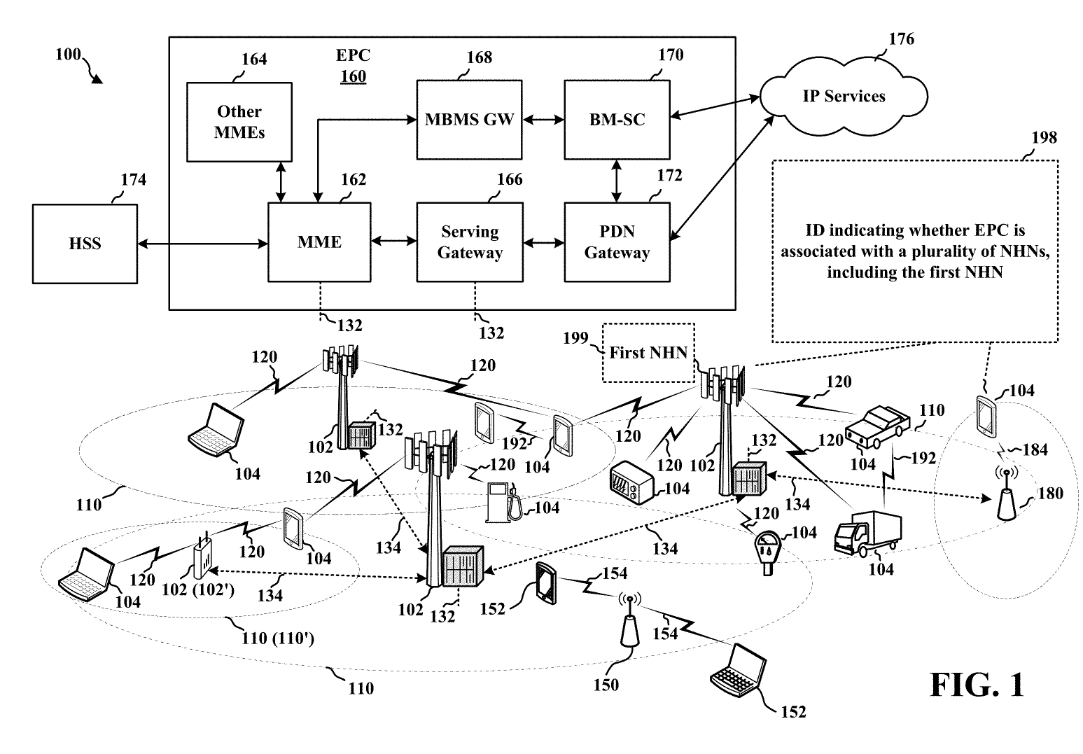

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 192. The D2D communication link 192 may use the DL/UL WWAN spectrum. The D2D communication link 192 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, a first base station 102 may be provided. The first base station 102 may be included in a first neutral host network (NHN) 199. In various aspects, the first base station 102 may determine whether an EPC 160 is associated with a plurality of NHNs, including the first NHN 199. The first base station 102 may transmit an identifier (ID) 198, and the ID 198 may be associated with the first NHN 199 and the EPC 160. In an aspect, the ID 198 indicates whether the EPC 160 is associated with the plurality of NHNs, including the first NHN 199. In an aspect, the ID 198 includes a first value when the EPC 160 is associated with the plurality of NHNs, and the ID 198 includes a second value when the EPC 160 is associated with the first NHN 199 and unassociated with the plurality of NHNs. In an aspect, the first value is located in a first portion of the ID 198. In an aspect, when the ID 198 includes the first value, EPC information associated with the EPC 160 is located in a second portion of the ID, and NHN information associated with the first NHN 199 is located in a third portion of the ID 198. In an aspect, when the ID 198 includes the second value, NHN information associated with the first NHN 199 occupies a remaining portion of the ID 198 following the second value. In an aspect, the ID 198 implicitly indicates whether the EPC 160 is associated with the plurality of NHNs based on whether EPC information associated with the EPC 160 is included in the ID 198. In an aspect, the ID 198 implicitly indicates that the EPC 160 is associated with the plurality of NHNs, including the first NHN 199, when the EPC information associated with the EPC 160 is included in the ID 198.

The UE 104 may receive, from the first NHN 199 through the first base station 102, the ID 198. The UE 104 may determine, based on the ID 198, whether the EPC is associated with the plurality of NHNs, including the first NHN 199. In an aspect, the UE 104 may receive, from a second network, a second ID including second NHN information associated with a second NHN, and the UE 104 may determine, based on the second ID, whether the second NHN is associated with the EPC 160 when the EPC 160 is associated with the plurality of NHNs. In an aspect, the UE 104 may perform a tracking area update (TAU) procedure associated with the second NHN when the EPC 160 is associated with the plurality of NHNs, including the first NHN 199 and the second NHN. In an aspect, the UE 104 may perform an attach procedure associated with the second NHN when the second NHN is unassociated with the EPC 160.

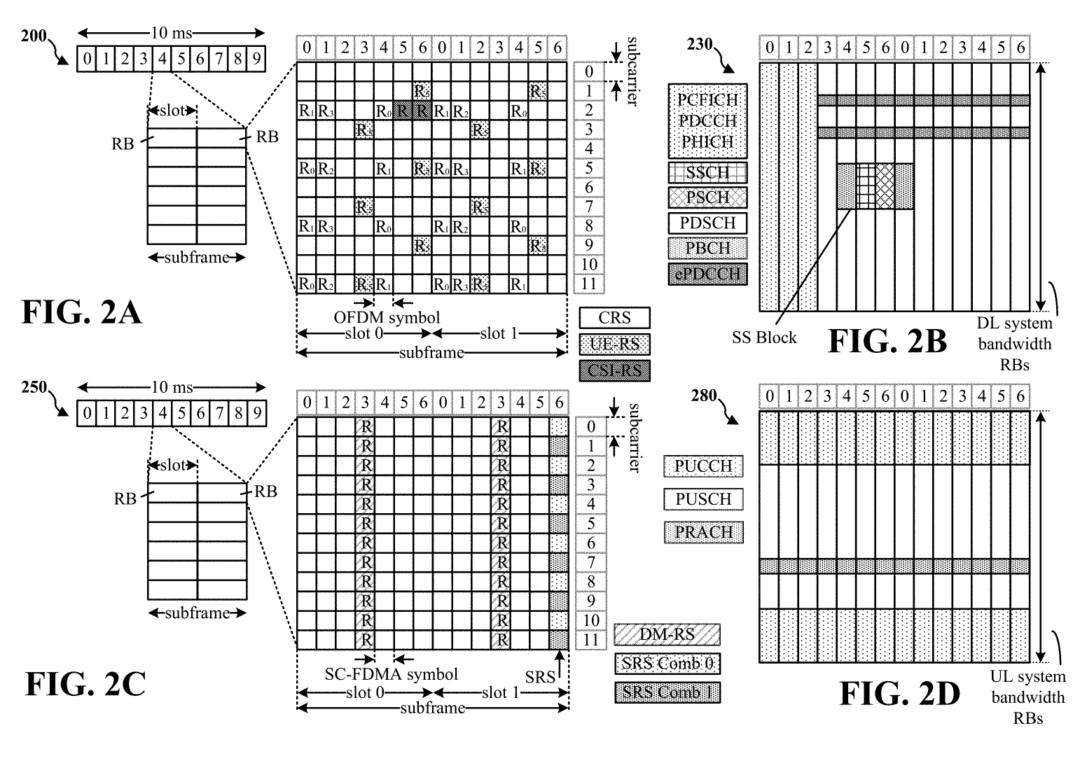

FIG. 2A is a diagram 200 illustrating an example of a DL frame structure. FIG. 2B is a diagram 230 illustrating an example of channels within the DL frame structure. FIG. 2C is a diagram 250 illustrating an example of an UL frame structure. FIG. 2D is a diagram 280 illustrating an example of channels within the UL frame structure. Other wireless communication technologies may have a different frame structure and/or different channels. A frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). For a normal cyclic prefix, an RB may contain 12 consecutive subcarriers in the frequency domain and 7 consecutive symbols (for DL, OFDM symbols; for UL, SC-FDMA symbols) in the time domain, for a total of 84 REs. For an extended cyclic prefix, an RB may contain 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R₀, R₁, R₂, and R₃, respectively), UE-RS for antenna port 5 (indicated as R₅), and CSI-RS for antenna port 15 (indicated as R).

FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE 104 to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS) block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

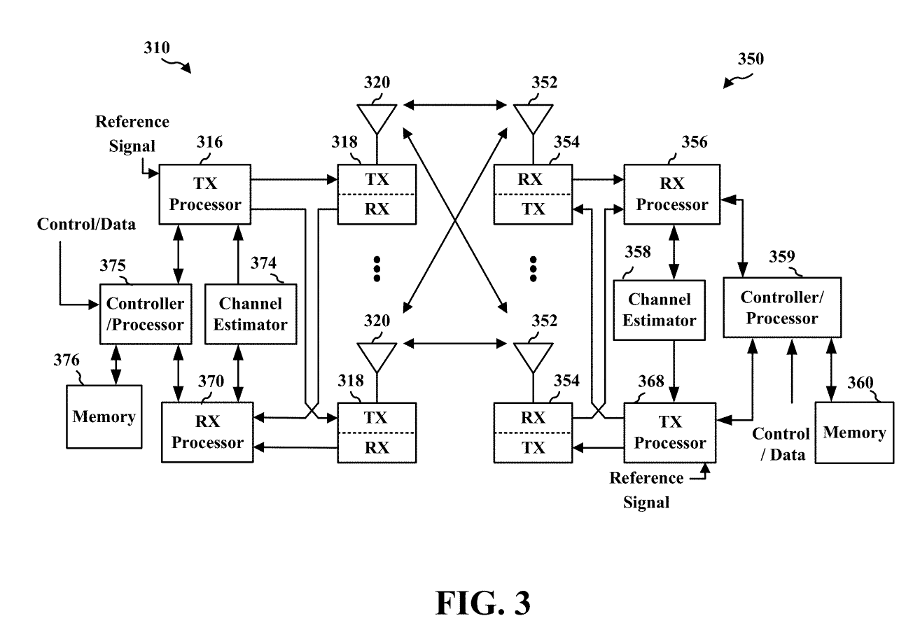

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

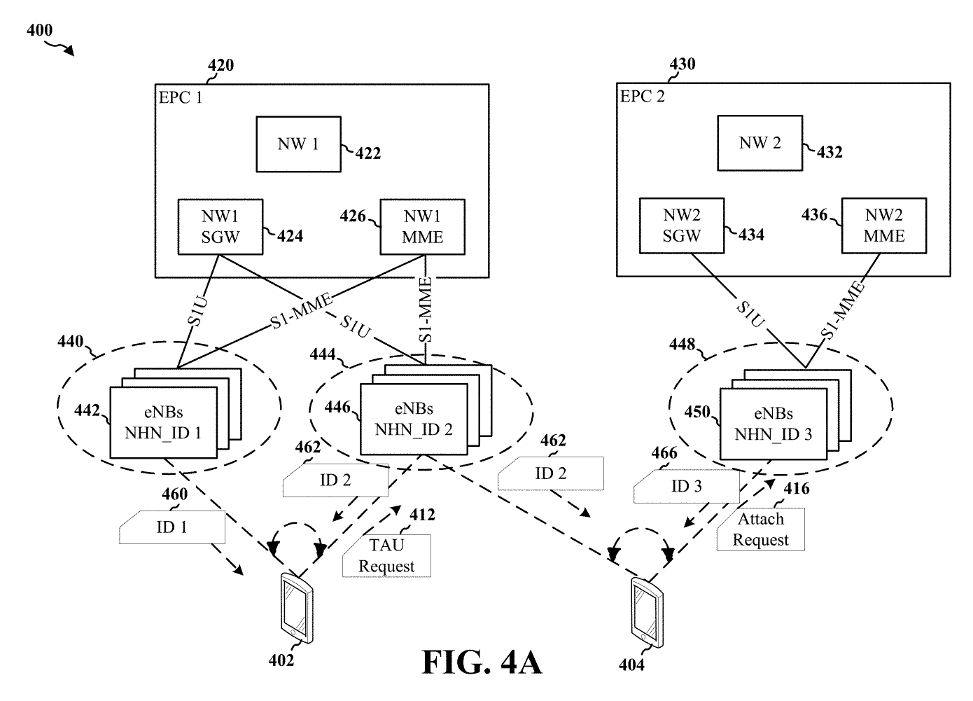

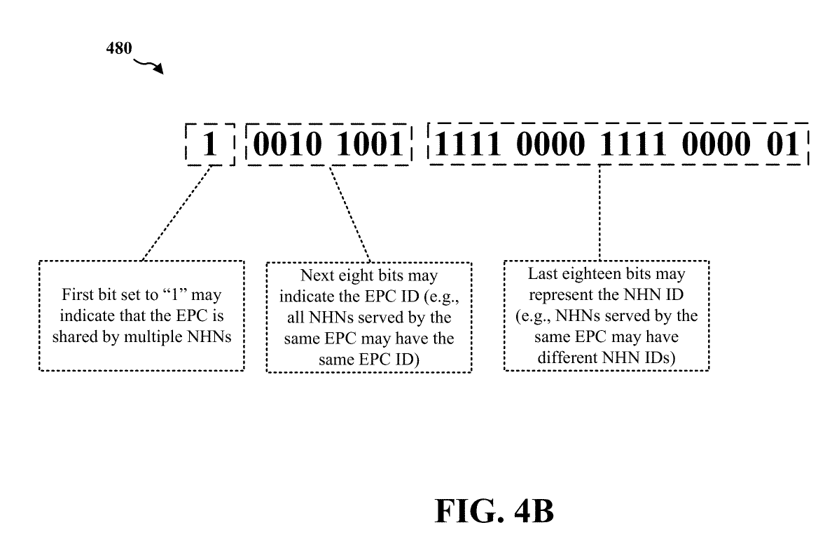

FIG. 4A is a diagram of a wireless communications system 400. In aspects, the wireless communications system 400 may include a plurality of EPCs 420, 430 (e.g., similar to the EPC 160). Each EPC 420, 430 may provide a respective network 422, 432 and include respective gateways 424, 434 as well as respective MMES 426, 436. Access to the EPCs 420, 430 may be provided through a plurality NHNs 440, 440, 448, which include respective eNBs 442, 446, 450. In other aspects, the eNBs 442, 446, 450 may be gNBs or other base stations.

According to aspects, an NHN may provide a wireless network with connectivity (e.g., internet connectivity) to UEs. An NHN may provide scalable network deployments to service UEs from a plurality service provides of a plurality of mobile networks. Such network deployments of an NHN may be self-contained. An NHN may operate according to one or more wireless standards, such as LTE, LTE-Unlicensed (LTE-U), LTE-Advanced (LTE-A), Licensed Assisted Access (LAA), fifth generation (5G) new radio (NR), Wi-Fi, and/or other radio access technologies.

The MulteFire Alliance may specify an NHN architecture based on 3GPP Evolved Packet System (EPS) architecture. This architecture may allow self-contained deployment of NHNs independently by venues and enterprises with relatively minimal interworking with mobile network operators (MNOs).

In an aspect, the wireless communications system 400 may include one or more MulteFire networks. A MulteFire network may include APs and/or eNB(s) communicating in an unlicensed radio frequency spectrum band (e.g., without a licensed frequency anchor carrier). For example, a MuLTEFire network may operate without an anchor carrier in the licensed spectrum. In an aspect, the first eNBs 442 of the first NHN 440, the second eNBs 446 of the second NHN 444, and/or the third eNBs 450 of the third NHN 448 are configured to operate under a MuLTEFire standard in the wireless communications system 400.

In an aspect, a first EPC 420 may be shared among a plurality of networks, e.g., the first EPC 420 may be a common EPC. That is, a first EPC 420 may be associated with a plurality of networks. For example, a plurality of NHNs 440, 444 may be associated with the first EPC 420 and, accordingly, be associated with the first serving gateway (SGW) 424 and be associated with the first MME 426.

In an aspect, a second EPC 430 may be a dedicated EPC and include only one network. For example, a third NHN 448 may be associated with the second EPC 430 and, therefore, a second SGW 434 and a second MME 436 of the second EPC 430 serve the third NHN 448.

In aspects, the eNBs 442, 446, 450 are configured to communicate with respective SGWs 424, 434 using an S1U interface. Further, the eNBs 442, 446, 450 are configured to communicate with respective MMEs 426, 436 using an S1-MME interface.

In an aspect, the first NHN 440 (e.g., at least one first eNB 442) may determine whether the first NHN 440 shares the first EPC 420 with the second NHN 444. For example, the first NHN 440 may determine whether the first EPC 420 is associated with a plurality of NHNs, including the first NHN 440. The first NHN 440 (e.g., at least one first eNB 442) may generate a message that includes a first ID 460. The first ID 460 may be associated with the first NHN 440 and the first EPC 420. The first ID 460 may indicate whether the first EPC 420 is associated with the plurality of NHNs, including the first NHN 440.

In an aspect, the first ID 460 may include a plurality of bits. In one aspect, the first bit may indicate whether the first EPC 420 is associated with (e.g., shared by or common to) the first and second NHNs 440, 444. For example, the first bit may be set to “1” to indicate that the first EPC 420 is shared by the first and second NHNs 440, 444. In an aspect, the next eight bits following the first bit may represent an ID associated with the first EPC 420, and a remaining eighteen bits may represent an ID associated with the NHN. For example, the first ID 460 may be twenty-seven bits and may indicate “1 0010 1001 1111 0000 1111 0000 01”, where the first “1” indicates that the first EPC 420 is shared, the next eight bits “0010 1001” indicate an ID of the first EPC 420, and the last eighteen bits “1111 0000 1111 0000 01” indicate an ID of the first NHN 440.

In one aspect, the combination of the EPC ID and the NHN ID as the first ID 460 may indicate that the EPC is a shared or common EPC (e.g., that the first EPC 420 is associated with the first NHN 440 and at least the second NHN 444). For example, the first ID 460 may implicitly indicate whether the first NHN 440 is one of the two or more NHNs 440, 444 that share the first EPC 420. In an aspect, the presence of an EPC ID in the first ID 460 may implicitly indicate that the first EPC 420 is shared between a plurality of NHNs. In an aspect, the first bit may be absent (e.g., the first ID 460 may be twenty-six bits) or the first bit may not be reserved (e.g., the first bit may be used for the EPC ID or the NHN ID).

In an aspect, the second NHN 444 (e.g., at least one second eNB 446) may determine whether the second NHN 444 shares the first EPC 420 with the first NHN 440. The second NHN 444 (e.g., at least one second eNB 446) may generate a message that includes a second ID 462. The second ID 462 may be associated with the second NHN 444 and the first EPC 420. The second ID 462 may indicate whether the second NHN 444 is one of the two or more NHNs that are associated with the first EPC 420. In an aspect, the second ID 462 may include a plurality of bits (e.g., twenty-seven bits). In one aspect, a first portion (e.g., a first bit) may indicate whether the first EPC 420 is shared by the first and second NHNs 440, 444. For example, a first portion (e.g., the first bit) may be set to “1” (or another predetermined value) to indicate that the first EPC 420 is shared by the first and second NHNs 440, 444. In an aspect, a second portion (e.g., the next eight bits following the first bit) may represent an ID associated with the first EPC 420, and a third portion (e.g., a remaining eighteen bits) may represent an ID associated with the second NHN 444. For example, the second ID 462 may be twenty-seven bits and may indicate “1 0010 1001 1111 0000 1111 0000 00”, where the first “1” indicates that the first EPC 420 is associated with a plurality of NHNs, the next eight bits “0010 1001” indicate the ID of the first EPC 420, and the last eighteen bits “1111 0000 1111 0000 00” indicate an ID of the second NHN 444.

In one aspect, the combination of the EPC ID and the NHN ID as the second ID 462 may indicate that the EPC is a shared or common EPC associated with a plurality of NHNs. For example, the second ID 462 may implicitly indicate that the second NHN 444 is one of the two or more NHNs 440, 444 that share the first EPC 420. In an aspect, the presence of an EPC ID in the second ID 462 may implicitly indicate that the first EPC 420 is shared between multiple NHNs.

In an aspect, the third NHN 448 (e.g., at least one third eNB 450) may determine whether the second EPC 430 is unassociated with a plurality of NHNs. For example, the third NHN 448 may determine whether the second EPC 430 is dedicated to the third NHN 448. The third NHN 448 (e.g., at least one third eNB 450) may generate a message that includes a third ID 466. The third ID 466 may be associated with the third NHN 448 and the second EPC 430. The third ID 466 may indicate whether the second EPC 430 is not a common EPC associated with a plurality of NHNs (e.g., the second EPC 430 may be a dedicated EPC that is dedicated to the third NHN 448).

In an aspect, the third ID 466 may include a plurality of bits. In one aspect, a first portion (e.g., a first bit) may indicate whether the second EPC 430 is unassociated with a plurality of NHNs (e.g., whether the second EPC 430 is dedicated to the third NHN 448). For example, a first portion (e.g., a first bit) may be set to “0” to indicate that the second EPC 430 is dedicated to the third NHN 448. In an aspect, a second portion (e.g., a remaining twenty-six bits) may represent an ID associated with the third NHN 448. For example, the third ID 466 may be twenty-seven bits and may indicate “0 0010 1001 1111 0000 1111 0000 11”, where the first “0” indicates that the second EPC 430 is unassociated with a plurality of NHNs (e.g., the second EPC 430 is dedicated to the third NHN 448), and remaining twenty-six bits “0010 1001 1111 0000 1111 0000 11” indicate an ID of the third NHN 448.

In one aspect, the use of NHN ID as the third ID 466 may indicate that the EPC is a dedicated EPC. That is, the third ID 466 may implicitly indicate that the second EPC 430 is dedicated to the third NHN 448. For example, the absence of an EPC ID in the third ID 466 may implicitly indicate that the second EPC 430 is dedicated to the third NHN 448. In such an aspect, the first portion (e.g., first bit) to indicate whether the second EPC 430 is unassociated with a plurality of NHNs may be absent (e.g., the third ID 466 may be twenty-six bits) or the first portion (e.g., first bit) may be used as part of the ID of the third NHN 448.

In an aspect, each NHN 440, 444, 448 may transmit a respective ID 460, 462, 466. In an aspect, each NHN 440, 444, 448 may broadcast a respective ID 460, 462, 466. For example, at least one first eNB 442 may broadcast the first ID 460, e.g., so that a UE operating in a coverage area of the at least one first eNB 442 may receive the first ID 460. In one aspect, each NHN 440, 444, 448 may broadcast a respective ID 460, 462, 466 as system information (e.g., as a SIB).

The wireless communications system 400 may include a plurality of UEs 402, 404. The UEs 402, 404 may be aspects of the UE 104 of FIG. 1 and/or the UE 350 of FIG. 3. In various aspects, the UEs 402, 404 may be configured to operate according to a MuLTEFire standard in the wireless communications system 400 (e.g., the UEs 402, 404 may be configured to communicate over an unlicensed spectrum). In an aspect, each UE 402, 404 may need to register with an NHN. According to various aspects, the UEs 402, 404 may each register with an NHN. For example, the UEs 402, 404 may register with an NHN based on an ID (e.g., the first ID 460, the second ID 462, the third ID 466), which may be broadcast by an NHN.

As described, each NHN 440, 444, 448 may be associated with an ID and may be configured to transmit, through an eNB, the ID to a UE that registers with the NHN. In one aspect, the first UE 402 receives, from the first NHN 440, the first ID 460. The first UE 402 may determine whether the first EPC 420 is associated with a plurality of NHNs, including the first NHN 440, (e.g., determine whether the first NHN 440 shares the first EPC 420 with another NHN) based on the first ID 460 (e.g., based on an indication of the first ID 460). From the first ID 460, the first UE 402 may determine an ID of the first NHN 440 and an ID of the first EPC 420.

In one aspect, the first UE 402 registers with the first NHN 440, for example, using a network attachment procedure (e.g., transmission of an attach request). The network attachment procedure may establish context associated with the first UE 402 in the first EPC 420. For example, the network attachment procedure may set up at least one bearer associated with the first UE 402.

The first UE 402 may move to a different coverage area, e.g., an area covered by the second NHN 444. For example, the first UE 402 may be in an idle mode (e.g., RRC Idle) and may move to a second NHN 444 associated with at least one second eNB 446. Accordingly, the first UE 402 receives, from the second NHN 444, the second ID 462. The first UE 402 may determine, based on the second ID 462, whether the second NHN 444 is associated with the first EPC 420 (e.g., after determining that the first EPC 420 is associated with a plurality of NHNs, including the first NHN 440). For example, the first UE 402 may determine whether the second NHN 444 shares the first EPC 420 with the first NHN 440 based on the second ID 462.

In an aspect, the first UE 402 may detect an indication in the second ID 462 that indicates the first EPC 420 is shared. The first UE 402 may detect an ID of the first EPC 420 in the second ID 462. The first UE 402 may compare this ID of the first EPC 420 in the second ID 462 to the ID of the first EPC 420 indicated by the first ID 460. The first UE 402 may determine that the IDs match because the first EPC 420 is shared between the first and second NHNs 440, 444. Accordingly, the first UE 402 may determine that the first EPC 420 is common to the first and second NHNs 440, 444 covering the first UE 402.

Because the first EPC 420 is shared between by the first and second NHNs, the first UE 402 may have continuity (e.g., IP continuity and/or mobility) for PDN connections as the first UE 402 moves from the first NHN 440 to the second NHN 444. Thus, the first UE 402 may not need to perform another network attachment procedure (e.g., transmission of an attach request). For example, the first EPC 420 may include context associated with the first UE 402 and may have at least one bearer set up for the first UE 402.

Because the first UE 402 does not need to perform another network attachment procedure (e.g., because the first UE 402 already has context in the first EPC 420), the first UE 402 may perform a TAU procedure when moving to the second NHN 444. By way of example, a TAU procedure may allow the first UE 402 to enter a tracking area (e.g., associated with the second NHN 444) when the first UE 402 is unregistered in that tracking area (e.g., by the first MME 426) but the first UE 402 still has context in the first EPC 420. In order to initiate the TAU procedure, the first UE 402 may transmit a TAU request 412. Accordingly, when the first UE 402 moves to the second NHN 444 and determines that the first EPC 420 associated with the second NHN 444 is the first EPC 420 associated with the first NHN 440, the first UE 402 may transmit the TAU request 412. Based on the TAU procedure, the first UE 402 may be provided mobility and/or connectivity when the first UE 402 moves between the first NHN 440 and the second NHN 444.

Similar to the first UE 402, the second UE 404 receives, from the second NHN 444, the second ID 462. The second UE 404 may determine whether the second NHN 444 shares the first EPC 420 with another NHN based on the second ID 462, e.g., based on an indication in the second ID 462. That is, the second UE 404 may determine, based on the second ID 462, whether the first EPC 420 is associated with a plurality of NHNs, including the second NHN 444.

In one aspect, the second UE 404 registers with the second NHN 444, for example, using a network attachment procedure (e.g., transmission of an attach request). For example, the second UE 404 may determine, based on the second ID 462, an ID of the second NHN 444, and the second UE 404 may perform a network attach procedure with the second NHN 444.

According to the illustrated aspect, the second UE 404 may move to a different coverage area, e.g., an area covered by the third NHN 448. For example, the second UE 404 may be in an idle mode (e.g., RRC Idle) and may move to a cell provided by at least one third eNB 450. In various aspects, the second UE 404 receives, from the third NHN 448, the third ID 466. For example, the second UE 404 may receive the third ID 466 as a broadcast.

The second UE 404 may determine whether the third NHN 448 shares the second EPC 430 with the second NHN 444 based on the third ID 466. That is, the second UE 404 may determine, based on the third ID 466, whether the third NHN 448 is associated with the first EPC 420 when the first EPC 420 is associated with a plurality of NHNs (e.g., as determined based on the second ID 462).

In one aspect, the second UE 404 may determine that the second NHN 444 is associated with the first EPC 420, and determine that the first EPC 420 is associated with a plurality of NHNs (including the second NHN 444). However, the second UE 404 may determine, based on the third ID 466, that the third NHN 448 is unassociated with the first EPC 420. For example, the second UE 404 may detect an indication in the third ID 466 that indicates the second EPC 430 is dedicated to the third NHN 448.

The second UE 404 may detect an ID of the third NHN 448 in the third ID 466. Based on the indication in the third ID 466 (e.g., based on the presence of bit and/or the absence of an EPC ID), the second UE 404 may determine that the second EPC 430 is dedicated to the third NHN 448 and therefore is unassociated with the second NHN 444. In another aspect, the third ID 466 may indicate an EPC ID of the second EPC 430, and the second UE 404 may determine that an EPC ID indicated in the third ID 466 does not match the EPC ID indicated in the second ID 462. In such an aspect, the second UE 404 may determine that the second EPC 430 is unassociated with the second NHN 444.

When the second UE 404 determines that the second EPC 430 is unassociated with the second NHN 444 with which the second UE 404 has registered, the second UE 404 may determine that the second UE 404 is to perform a network attach procedure with the third NHN 448, e.g., because continuity (e.g., IP continuity and/or mobility) for PDN connections is not possible for the second UE 404 without a common EPC shared between the second NHN 444 and the third NHN 448. Accordingly, the second UE 404 may perform a network attachment procedure (e.g., transmission of an attach request). In aspects, the second UE 404 may transmit an attach request 416 when the second UE 404 moves to the third NHN 448 and determines that the third NHN 448 is unassociated with the first EPC 420. Thus, the second UE 404 may establish context in the second EPC 430 and at least one bearer may be set up for the second UE 404.

FIG. 4B illustrates a diagram of an ID 480. For example, the ID 480 may be an aspect of the first ID 460 of FIG. 4A. As illustrated, the ID 480 may include a plurality of bits. In one aspect, the first bit may indicate whether the first EPC 420 is associated with (e.g., shared by or common to) the first and second NHNs 440, 444. For example, the first bit may be set to “1” to indicate that the first EPC 420 is shared by the first and second NHNs 440, 444. In an aspect, the next eight bits following the first bit may represent an ID associated with the first EPC 420, and a remaining eighteen bits may represent an ID associated with the NHN. For example, the first ID 460 may be twenty-seven bits and may indicate “1 0010 1001 1111 0000 1111 0000 01”, where the first “1” indicates that the first EPC 420 is shared, the next eight bits “0010 1001” indicate an ID of the first EPC 420, and the last eighteen bits “1111 0000 1111 0000 01” indicate an ID of the first NHN 440.

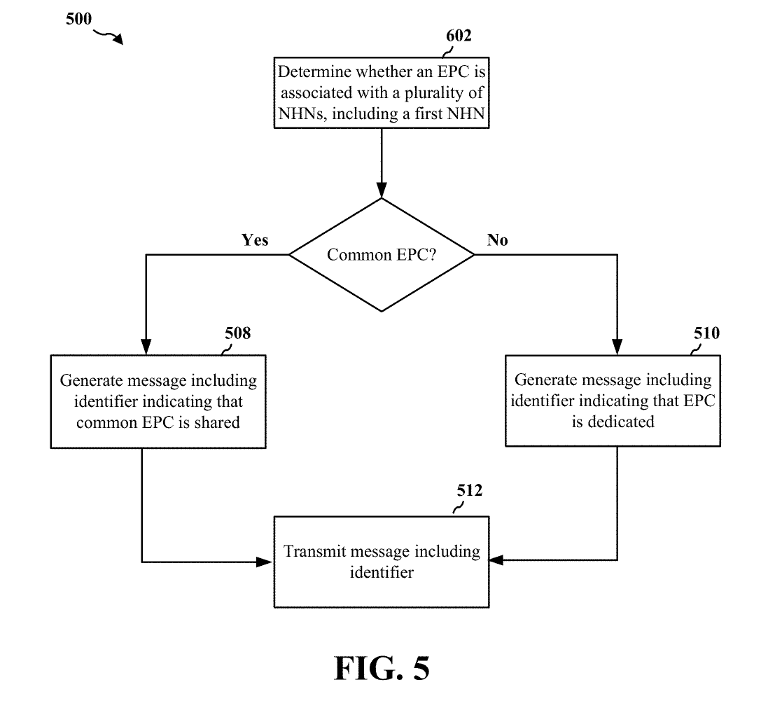

FIG. 5 is a flowchart of a method 500 of wireless communication. The method may be performed by an NHN system (e.g., at least one eNB of the eNBs 442, 446, 450, the apparatus 702/702′). Although FIG. 5 illustrates a plurality of operations, one of ordinary skill will appreciate that one or more operations may be transposed and/or contemporaneously performed. Further, one or more operations of FIG. 5 may be optional and/or performed in connection with one or more other operations.

Beginning first with operation 502, the NHN system may determine whether an EPC is associated with a plurality of NHNs, including the NHN system. For example, the NHN system may receive an indication from the EPC that the EPC is associated with at least one other NHN. The NHN system may receive such an indication from another system of the EPC, such as an MME or an SGW. In one aspect, the indication may identify the at least one NHN. In another aspect, the indication may indicate that the EPC is a common or shared EPC. The NHN system may then determine, based on the received indication, whether the EPC is associated with a plurality of NHNs. In another aspect, the NHN system may determine whether the EPC is associated with a plurality of NHNs based on an absence of an indication from the EPC. For example, the NHN system may determine that an indication that the EPC is associated with a plurality of NHNs is unreceived, and the NHN system may determine that the EPC is unassociated with a plurality of NHNs (e.g., that the EPC is dedicated to the NHN system). In the context of FIG. 4A, the first NHN 440 (e.g., at least one first eNB 442) may determine that the first EPC 420 is associated with a plurality of NHNs, including the first NHN 440 and the second NHN 444. In another aspect of FIG. 4A, the third NHN 448 (e.g., at least one third eNB 450) may determine that the second EPC 430 is dedicated to the third NHN 448.

If the NHN system determines that the EPC is associated with a plurality of NHNs (e.g., the EPC is a common or shared EPC), the method 500 may proceed to operation 508. At operation 508, the NHN system may generate a message that includes an ID indicating that the common EPC is shared. The ID may be associated with the NHN and/or the common EPC. In one aspect, the ID may include a first value indicating that the EPC is the common EPC. The first value may be located in a first portion of the ID (e.g., the first bit) and may be a predetermined value (e.g., “1”).

The ID may include EPC information associated with the common EPC (e.g., an EPC ID) in a second portion of the ID. For example, the NHN system may determine an ID associated with the EPC, such as by receiving the ID associated with the EPC from an MME or SGW, and the NHN system may include the ID associated with the EPC in the generated message. The ID may include information associated with the NHN (e.g., NHN ID) in a third portion of the ID. For example, the NHN system may identify an ID associated with the NHN system, which may be assigned to the NHN system or may be selected (e.g., randomly generated), and the NHN system may include the ID associated with the NHN in the generated message. In another aspect, the ID may implicitly indicate that the NHN is one of the two or more NHNs that share the common EPC. For example, the NHN system may include an ID associated with the EPC in order to implicitly indicate that the EPC is associated with a plurality of NHNs.

In the context of FIG. 4A, the first NHN 440 (e.g., at least one first eNB 442) may generate a message that includes the first ID 460. The first NHN 440 (e.g., the at least one first eNB 442) may generate a message that includes an ID associated with the first EPC 420 and an ID associated with the first NHN 440 in the first ID 460.

If the NHN system determines that the EPC is dedicated to the NHN, the method 500 may proceed to operation 510. At operation 510, the NHN system may generate a message that includes an ID indicating that the EPC is dedicated to the NHN. The ID may be associated with the NHN and the dedicated EPC. However, the ID may not include an ID associated with the EPC. For example, the NHN system may identify an ID associated with the NHN system, which may be assigned to the NHN system or may be selected (e.g., randomly generated), and the NHN system may include the ID associated with the NHN in the generated message.

In one aspect, the ID may include a second value indicating that the EPC is a dedicated EPC. The second value may be located in a first portion of the ID (e.g., the first bit). Information associated with the EPC (e.g., an EPC ID) may be absent from the ID. The ID may include information associated with the NHN (e.g., NHN ID) in a remaining portion of the ID. In one aspect, the ID may implicitly indicate that the NHN has a dedicated EPC (e.g., based on absence of information associated with the EPC (e.g., EPC ID). In the context of FIG. 4A, the third NHN 448 (e.g., at least one third eNB 450) may generate a message that includes the third ID 466. The first NHN 440 (e.g., the at least one first eNB 442) may generate a message that includes an ID associated with the third NHN 448 in the third ID 466.

Following both operation 508 and operation 510, the method 500 may proceed to operation 512. At operation 512, the NHN system may transmit the message indicating that the EPC is unassociated with a plurality of NHNs (e.g., the message may indicate that the EPC is dedicated to the NHN system). In one aspect, the NHN system may schedule the message on one or more resources (e.g., a channel and/or one or more subframes or slots), and the NHN system may transmit the message one the scheduled one or more resources. For example, the NHN system may schedule the message on a broadcast or shared channel, and the NHN system may broadcast the message on the scheduled channel. In the context of FIG. 4A, the first NHN 440 (e.g., at least one first eNB 442) may transmit (e.g., broadcast) the first ID 460. In another aspect of FIG. 4A, the third NHN 448 (e.g., at least one third eNB 450) may transmit (e.g., broadcast) the third ID 466.

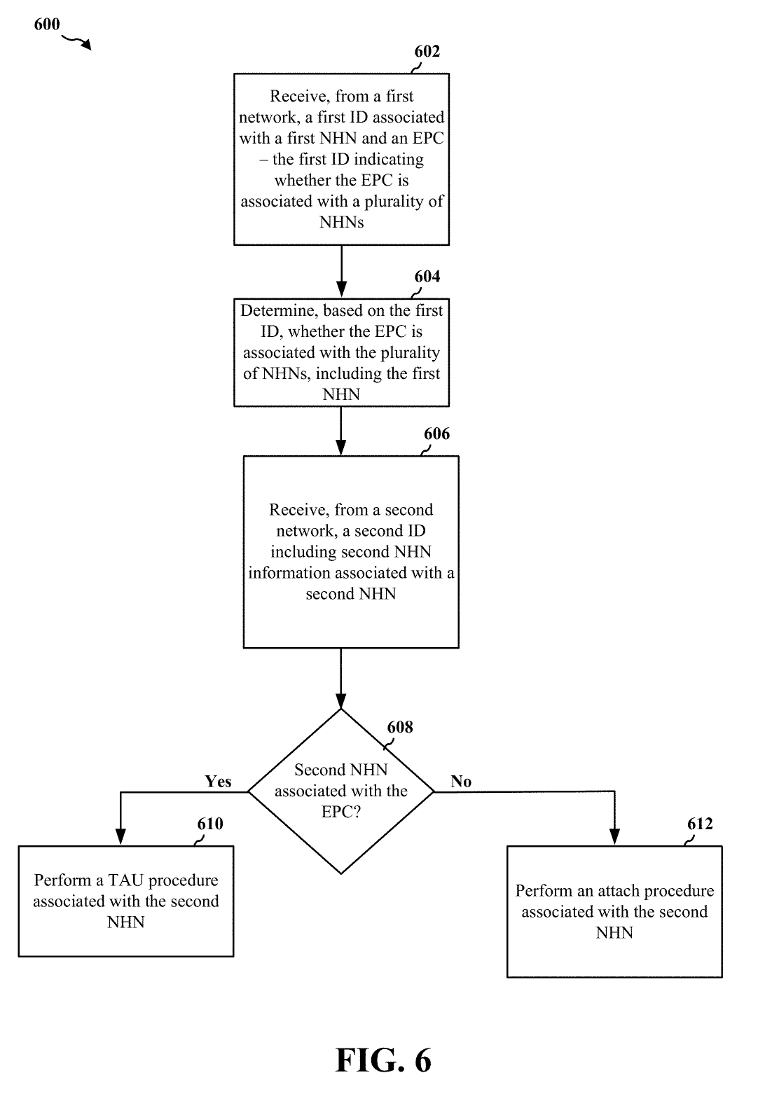

FIG. 6 is a flowchart of a method 600 of wireless communication. The method may be performed by a UE (e.g., the UE 402, the UE 404, the apparatus 902/902′). Although FIG. 6 illustrates a plurality of operations, one of ordinary skill will appreciate that one or more operations may be transposed and/or contemporaneously performed. Further, one or more operations of FIG. 6 may be optional and/or performed in connection with one or more other operations.

Beginning first with operation 602, the UE may receive, from a first network, a first ID associated with a first NHN and a first EPC. The first ID may indicate whether the first EPC is associated with a plurality of NHNs.

In one aspect, the first ID may be associated with the NHN and a common or shared EPC that is associated with a plurality of NHNs. The first ID may include a first value indicating that the first EPC is a common EPC—e.g., the first value may be a predetermined value indicating that the first EPC is associated with a plurality of NHNs, such as “1”. The first value may be located in a first portion of the first ID (e.g., the first bit). The first ID may include EPC information associated with the first EPC (e.g., a first EPC ID) in a second portion of the first ID. The first ID may include NHN information associated with the first NHN (e.g., NHN ID) in a third portion of the first ID.

In one aspect, the first ID may implicitly indicate that the first EPC is associated with a plurality of NHNs, including the first NHN. For example, inclusion of EPC information associated with the first EPC (e.g., a first EPC ID) may implicitly indicate that the first EPC is associated with a plurality of NHNs.

In another aspect, the first ID may include a second value (e.g., different from the first value) indicating that the first EPC is unassociated with a plurality of NHNs—e.g., the second value may be a predetermined value indicating that the first EPC is dedicated to the first NHN, such as “0”. The second value may be located in a first portion of the first ID (e.g., the first bit). EPC Information associated with the first EPC (e.g., a first EPC ID) may be absent from the first ID. The first ID may include information associated with the first NHN (e.g., NHN ID) in a remaining portion of the ID. In one aspect, the first ID may implicitly indicate that the first NHN has a dedicated EPC (e.g., based on absence of EPC information associated with the first EPC (e.g., a first EPC ID).

In the context of FIG. 4A, the first UE 402 may receive the first ID 460 from the first NHN 440. In another aspect of FIG. 4A, the second UE 404 may receive the second ID 462 from the second NHN 444.

At operation 604, the UE may determine whether the first EPC is associated with the plurality of NHNs, including the first NHN, based on the first ID. In one aspect, the UE may detect a value of a bit in the received first ID that indicates that first EPC is a common EPC shared by the first NHN and the second NHN. Based on the detected value of the bit, the UE may determine whether the first EPC is associated with the plurality of NHNs. For example, the UE may detect a first value (e.g., “1”) that is predetermined to indicate that the first EPC is associated with a plurality of NHNs, and the UE may determine that the first EPC is associated with the plurality of NHNs based on the detection of the first value. In another example, the UE may detect a second value (e.g., “0”) that is predetermined to indicate that the first EPC is unassociated with a plurality of NHNs, and the UE may determine that the first EPC is associated with the plurality of NHNs based on detection of the second value.

In another aspect, the UE may detect an EPC ID in the first ID, which may indicate to the UE that the first EPC is a common EPC associated with a plurality of NHNs. Accordingly, the UE may determine that the first EPC is associated with the plurality of NHNs based on the detected EPC ID. In another aspect, the UE may determine that an EPC ID is absent from the first ID, which may indicate that the first EPC is unassociated with a plurality of NHNs (e.g., the first EPC is dedicated to the first NHN). Accordingly, the UE may determine that the first EPC is unassociated with the plurality of NHNs (e.g., the UE may determine that the first EPC is dedicated to the first NHN).

In the context of FIG. 4A, the first UE 402 may determine that the first EPC 420 is associated with a plurality of NHNs, including the first NHN 440, based on at least one of the first ID 460. In another aspect of FIG. 4A, the second UE 404 may determine that the first EPC 420 is associated with a plurality of NHNs, including the second NHN 444, based on the second ID 462.

At operation 606, the UE may receive, from a second network, a second ID associated with the second NHN. The second ID may indicate whether a second EPC associated with the second NHN is associated with a plurality of NHNs, including the second NHN. The second ID may include a first value indicating that the second EPC is associated with a plurality of NHNs. The first value may be located in a first portion of the second ID (e.g., the first bit). The second ID may include EPC information associated with the second EPC (e.g., a second EPC ID) in a second portion of the second ID. The second ID may include NHN information associated with the second NHN (e.g., a second NHN ID) in a third portion of the second ID.

In one aspect, the second ID may implicitly indicate that the second EPC is associated with a plurality of NHNs (e.g., based on inclusion of EPC information associated with the second EPC (e.g., a second EPC ID). In another aspect, the second ID may include a second value indicating that the second EPC is unassociated with a plurality of NHNs (e.g., the second EPC may be a dedicated EPC). The second value may be located in a first portion of the second ID (e.g., the first bit). EPC information associated with the second EPC (e.g., a second EPC ID) may be absent from the second ID. The second ID may include NHN information associated with the NHN (e.g., a second NHN ID) in a remaining portion of the second ID. In one aspect, the second ID may implicitly indicate that the second NHN has a dedicated EPC (e.g., based on absence of information associated with the second EPC (e.g., a second EPC ID). In the context of FIG. 4A, the first UE 402 may receive the second ID 462 from the second NHN 444. In another aspect of FIG. 4A, the second UE 404 may receive the third ID 466 from the third NHN 448.

At operation 608, the UE may determine, based on the second ID, whether the second NHN is associated with the first EPC when the second EPC is associated with a plurality of NHNs. In one aspect, the UE may detect a first value of a bit that indicates whether the second EPC is a common EPC associated with a plurality of NHNs. In another aspect, the UE may detect the second EPC ID in the second identifier, which indicates that the second EPC is associated with a plurality of NHNs. When the UE determines that both the first EPC and the second EPC are associated with a plurality of NHNs, the UE may identify the second EPC ID indicated by the second identifier and identify the first EPC ID indicated by the first identifier. The UE may compare the first EPC ID and the second EPC ID. The UE may determine that the first EPC ID matches the second EPC ID and, therefore, may determine that the first EPC is the second EPC, which is an EPC associated with the first NHN and the second NHN. If the UE determines that the first EPC ID and the second EPC ID do not match, the UE may determine that the second NHN is not associated with the first EPC.

In another aspect, the UE may detect a second value of a bit that indicates whether the second EPC is unassociated with a plurality of NHNs (e.g., the second EPC may be dedicate to the second NHN). In another, the absence of the second EPC ID may indicate, to the UE, that the second EPC is unassociated with a plurality of NHNs (e.g., the second EPC is dedicated to the second NHN). Accordingly, the UE may determine that the second NHN is not associated with the first EPC.

In the context of FIG. 4A, the first UE 402 may determine whether the first EPC 420 is a common EPC associated with the first NHN 440 and the second NHN 444 based on respective bits included in the first and second IDs 460, 462 (e.g., respective EPC IDs included in respective second portions of the first and second IDs 460, 462). In another aspect of FIG. 4A, the second UE 404 may determine that the second EPC 430 is a dedicated EPC based on one or more bits included in the third ID 466 (e.g., a bit value in a first portion and/or an absence of an ID of the second EPC 430).

If the first EPC is a common EPC that is associated the first NHN and the second NHN (i.e., the first EPC is the second EPC), then the UE may perform a TAU procedure based on information associated with the EPC and information associated with the second NHN, as illustrated at operation 610. For example, the UE may generate a TAU request, and the UE may transmit the TAU request to the second NHN. In one aspect, the TAU request may be based on the NHN information included in the second ID (e.g., the UE may include the second NHN ID in the TAU request). In the context of FIG. 4A, the first UE 402 may transmit the TAU request 412 to the second NHN 444 (e.g., to the at least one second eNB 446).

If the second EPC is different from the first EPC (e.g., the second EPC is dedicated to the second NHN), then the UE may perform an attachment procedure associated with the second NHN, as illustrated at operation 612. For example, the UE may generate an attach request, and the UE may transmit the attach request to the second NHN. In one aspect, the network attach request may be based on the NHN information included in the second ID (e.g., the UE may include the second NHN ID in the network attach request). In the context of FIG. 4A, the second UE 404 may transmit the attach request 416 to the third NHN (e.g., to the at least one third eNB 450).

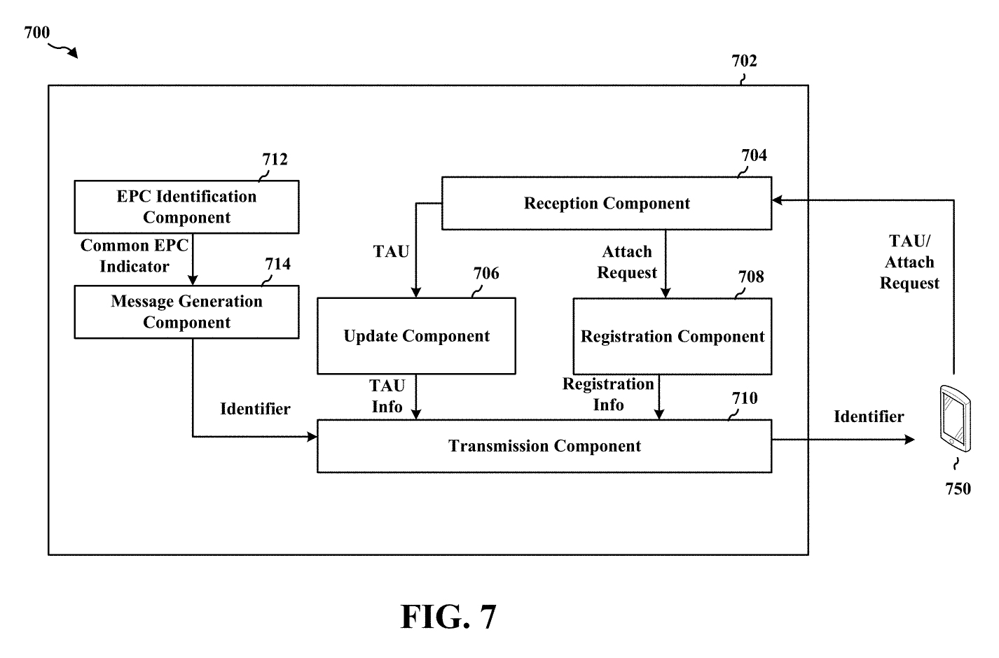

FIG. 7 is a conceptual data flow diagram 700 illustrating the data flow between different means/components in an exemplary apparatus 702. The illustrated components and data flow are illustrative, and the apparatus 702 may include different/additional components and/or different/additional data flow.

The apparatus 702 may be associated with a first NHN, e.g., the apparatus 702 may be at least one of the first eNBs 442 of the first NHN 440, at least one of the second eNBs 446 of the second NHN 444, and/or at least one of the third eNBs 450 of the third NHN 448.

The apparatus 702 includes a reception component 704 configured to receive signals, e.g., from the UE 750. The apparatus includes a transmission component 710 configured to transmit signals, e.g., as broadcast and/or to the UE 750.

The apparatus 702 further includes an EPC identification component 712. The EPC identification component 712 may be configured to determine whether an EPC is associated with a plurality of NHNs, including the a first NHN associated with the apparatus 702. The EPC identification component 712 may provide an indication of whether the EPC is associated with the plurality of NHNs, including the first NHN, to a message generation component 714.

The message generation component 714 may be configured to generate a message that includes an ID based on whether the EPC is associated with the plurality of NHNs, including the first NHN. The message generation component 714 may generate the message to include an ID that indicates if the EPC is associated with the plurality of NHNs, including the first NHN. In one aspect, the ID may be associated with the NHN and the EPC. The message generation component 714 may generate the message to include an ID having a first value indicating that the EPC is the common EPC associated with the plurality of NHNs. The first value may be located in a first portion of the ID (e.g., the first bit). The message generation component 714 may generate the message to include an ID having EPC information associated with the common EPC (e.g., an EPC ID) in a second portion of the ID. The message generation component 714 may generate the message to include an ID having NHN information associated with the NHN (e.g., NHN ID) in a third portion of the first ID. In one aspect, the message generation component 714 may generate the message to include an ID that implicitly indicates that the first NHN is one of the two or more NHNs that share the common EPC (e.g., based on inclusion of EPC information associated with the EPC (e.g., EPC ID) in the message).

In another aspect, the message generation component 714 may generate an ID to include a second value indicating that the EPC is unassociated with a plurality of NHNs (e.g., to indicate the EPC is a dedicated EPC). The second value may be located in a first portion of the first ID (e.g., the first bit). The message generation component 714 may generate the message so that EPC information associated with the EPC (e.g., an EPC ID) is absent from the ID. The message generation component 714 may generate the ID to include NHN information associated with the first NHN (e.g., NHN ID) in a remaining portion of the ID following the first portion. In one aspect, the message generation component 714 may generate the message to include an ID that implicitly indicates that the first NHN has a dedicated EPC (e.g., based on absence of information associated with the EPC (e.g., EPC ID)). The message generation component 714 may provide this generated message, including the ID, to the transmission component 710. The transmission component 710 may transmit (e.g., broadcast) this message.

When a UE 750 is within a coverage area of the apparatus 702, the UE 750 may transmit either a TAU request or an attach request to the apparatus 702. If the first NHN associated with the apparatus 702 shares an EPC another NHN and the UE 750 is moving between these NHNs, the UE 750 may send a TAU request. The apparatus 702 may receive this TAU request at an update component 706, which may provide IP mobility and/or PDN connectivity to the UE 750 (e.g., through completion of the TAU procedure). For example, the update component 706 may send this TAU request to an MME and/or SGW of the EPC in order to continue a TAU procedure with the UE 750.

If the apparatus 702 does not share an EPC another NHN and/or the UE is moving from an NHN that does not share an EPC with the apparatus 702, the UE 750 may send an attach request. Therefore, the UE 750 may register with the first NHN associated with the apparatus 702. Accordingly, the apparatus 702 may receive an attach request. The apparatus 702 may process the attach request at a registration component 708. For example, the registration component 708 may send this attach request to an MME and/or SGW of the EPC in order to continue a network attach procedure with the UE 750.

The apparatus may include additional components that perform each of the blocks of the algorithm in the aforementioned flowcharts of FIG. 5. As such, each block in the aforementioned flowcharts of FIG. 5 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

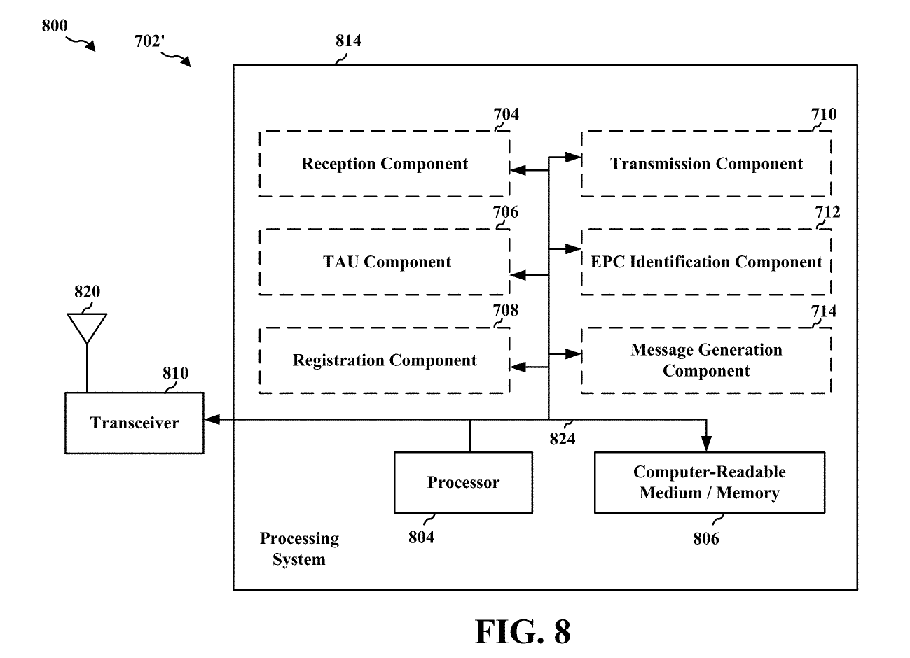

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 708, 710, 712, 714 and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception component 704. In addition, the transceiver 810 receives information from the processing system 814, specifically the transmission component 710, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 708, 710, 712, 714. The components may be software components running in the processor 804, resident/stored in the computer readable medium/memory 806, one or more hardware components coupled to the processor 804, or some combination thereof. The processing system 814 may be a component of the base station 310 and may include the memory 376 and/or at least one of the TX processor 316, the RX processor 370, and the controller/processor 375.

In one configuration, the apparatus 702/702′ for wireless communication includes means for determining whether an EPC is associated with a plurality of NHNs, including the first NHN. The apparatus 702/702′ may further include means for transmitting an identifier. In an aspect, the identifier may be associated with at least one of the first NHN and the EPC. In an aspect, the identifier indicates whether the EPC is associated with the plurality of NHNs, including the first NHN. In an aspect, the identifier includes a first value when the EPC is associated with the plurality of NHNs, and wherein the identifier includes a second value when the EPC is associated with the first NHN and unassociated with the plurality of NHNs. In an aspect, the first value is located in a first portion of the identifier. In an aspect, when the identifier includes the first value, EPC information associated with the EPC is located in a second portion of the identifier, and NHN information associated with the first NHN is located in a third portion of the identifier. In an aspect, when the identifier includes the second value, NHN information associated with the first NHN occupies a remaining portion of the identifier following the second value. In an aspect, the identifier implicitly indicates whether the EPC is associated with the plurality of NHNs based on whether EPC information associated with the EPC is included in the identifier. In an aspect, the identifier implicitly indicates that the EPC is associated with the plurality of NHNs, including the first NHN, when the EPC information associated with the EPC is included in the identifier.

The aforementioned means may be one or more of the aforementioned components of the apparatus 702 and/or the processing system 814 of the apparatus 702′ configured to perform the functions recited by the aforementioned means. As described supra, the processing system 814 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

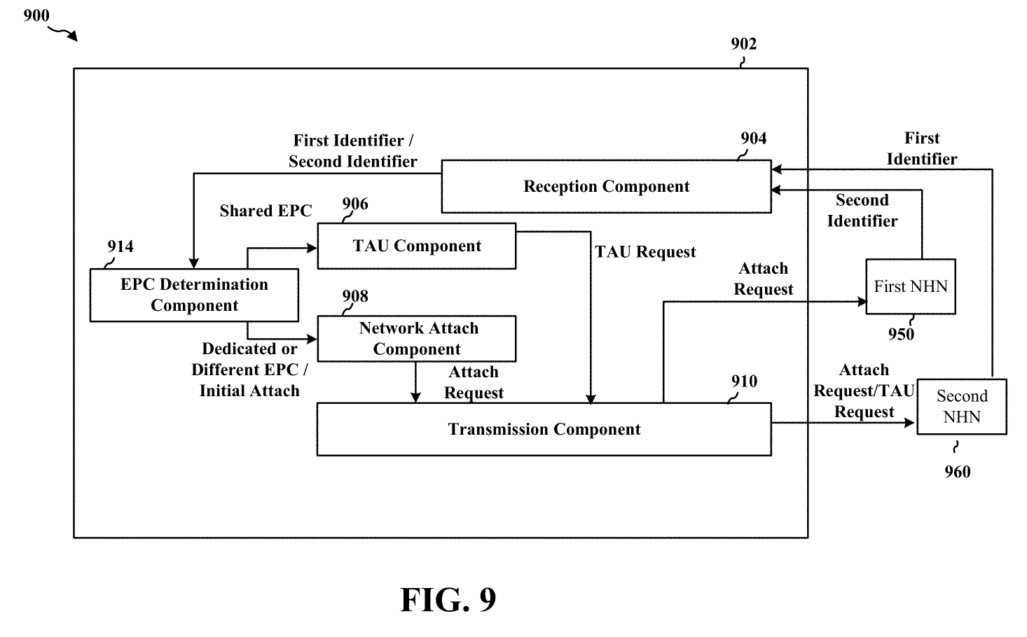

FIG. 9 is a conceptual data flow diagram 900 illustrating the data flow between different means/components in an exemplary apparatus 902. The illustrated components and data flow are illustrative, and the apparatus 902 may include different/additional components and/or different/additional data flow.

The apparatus 902 may be a UE. The apparatus 902 includes a reception component 904 configured to receive signals, e.g., from a first NHN 950 and/or a second NHN 960. The apparatus 902 includes a transmission component 910 configured to transmit signals, e.g., to a first NHN 950 and/or a second NHN 960.

The reception component 904 may be configured to receive a first ID broadcast by the first NHN 950. The first ID may be associated with a first NHN and a first EPC. The first ID may indicate whether the first EPC is associated with a plurality of NHNs, including the first NHN. The reception component 904 may provide the first ID to an EPC determination component 914.

The EPC determination component 914 may determine, based on the first ID, whether the first EPC is associated with a plurality of NHNs, including the first NHN 950. The first ID may include EPC information associated with the first EPC (e.g., a first EPC ID) and NHN information associated with the first NHN 950. The EPC determination component 914 may determine that the first EPC is associated with a plurality of NHNs. For example, the EPC determination component 914 may determine that the first EPC is associated with a plurality of NHNs when the first ID includes a first value indicating that the first EPC is associated with a plurality of NHNs. In an aspect, the first value may be located in a first portion of the ID, the EPC information associated with the first EPC is located in a second portion, and the NHN information associated with the first NHN 950 is located in a third portion. In another aspect, the EPC determination component 914 may determine that the first EPC is associated with a plurality of NHNs when the EPC determination component 914 detects the EPC information associated with the first EPC (e.g., the first EPC ID). That is, the first ID may implicitly indicate that the first EPC is associated with a plurality of NHNs based on the inclusion of the EPC information associated with the first EPC in the first ID.

In an aspect, the EPC determination component 914 may determine that the apparatus 902 is to perform an initial attachment (e.g., the apparatus 902 may not be attached to any network). Accordingly, the EPC determination component 914 may provide NHN information associated with the first NHN 950 to the network attach component 908. The network attach component 908 may perform a network attach procedure with the first NHN 950. For example, the network attach component 908 may transmit an attach request to the first NHN 950. Subsequently, the apparatus 902 may be provided context in the first EPC (e.g., at least one bearer may be set up for the apparatus 902).

In aspects, the apparatus 902 may move to a different area, which may be covered by the second NHN 960. The EPC determination component 914 may receive, through the reception component 904, a second ID from the second NHN 960. The second ID may be associated with the second NHN 960 and a second EPC, and the second ID may indicate whether the second EPC is associated with a plurality of NHNs. The second ID may include NHN information associated with the second NHN 960 (e.g., a second NHN ID).

The EPC determination component 914 may determine whether the first EPC is the same as the second EPC or if the second EPC is different from the first EPC. In one aspect, the EPC determination component 914 may determine whether the second EPC, associated with the second NHN 960, is associated with a plurality of NHNs. For example, the EPC determination component 914 may detect, in the second ID, a first value (e.g., “1”) that indicates that the second EPC is associated with a plurality of NHNs. The first value may be included in a first portion of the second ID. In another example, the EPC determination component 914 may detect, in the second ID, EPC information associated with the second EPC (e.g., a second EPC ID), and the inclusion of the EPC information may indicate that the second EPC is associated with a plurality of NHNs.

When the second EPC is associated with a plurality of NHNs, the EPC determination component 914 may detect EPC information associated with the second EPC (e.g., a second EPC ID). The EPC information may be in a second portion of the second ID (e.g., following the first portion). The EPC determination component 914 may further detect NHN information associated with the second NHN 960 (e.g., a second NHN ID). The EPC determination component 914 may compare EPC information associated with the first EPC to EPC information associated with the second EPC—e.g., the EPC determination component 914 may compare the first EPC ID to the second EPC ID. Based on the comparison, the EPC determination component 914 may determine whether the first EPC is the same as the second EPC—e.g., when the first EPC ID matches the second EPC ID, the EPC determination component 914 may determine that the first and second EPCs are a same EPC shared between the first and second NHNs 950, 960.

When the EPC determination component 914 determines that the first and second EPCs are a same EPC associated with the first and second NHN 950, 960. The EPC determination component 914 may provide an indication of the shared or common EPC to a TAU component 906.

The TAU component 906 may perform a TAU procedure with the second NHN 960, e.g., because the apparatus 902 has context in the shared EPC. Accordingly, the TAU component 906 may generate a TAU request and provide the TAU request to the transmission component 910. The transmission component 910 may transmit the TAU request to the second NHN 960.

In another aspect, the EPC determination component 914 may determine whether the second EPC, associated with the second NHN 960, is unassociated with the first NHN 950. For example, the EPC determination component 914 may detect, in the second ID, a second value (e.g., “0”) that indicates that the second EPC is unassociated with a plurality of NHNs (e.g., the second EPC is dedicated to the second NHN 960). The second value may be included in a first portion of the second ID. In an aspect, the NHN information associated with the second NHN 960 may be included in a second portion of the second ID (e.g., the remaining bits of the second ID following the first portion). In another example, the EPC determination component 914 may detect, in the second ID, an absence of EPC information associated with the second EPC (e.g., a second EPC ID), and the absence of the EPC information may indicate that the second EPC is unassociated with a plurality of NHNs (e.g., the second EPC is dedicated to the second NHN 960). For example, the EPC determination component 914 may determine that NHN information associated with the second NHN 960 (e.g., a second NHN ID) occupies all bits of the second ID.

In another aspect, the EPC determination component 914 may detect EPC information associated with the second EPC (e.g., a second EPC ID). The EPC information may be in a second portion of the second ID (e.g., following the first portion). The EPC determination component 914 may compare EPC information associated with the first EPC to EPC information associated with the second EPC—e.g., the EPC determination component 914 may compare the first EPC ID to the second EPC ID. Based on the comparison, the EPC determination component 914 may determine whether the first EPC is the same as the second EPC—e.g., when the first EPC ID does not match the second EPC ID, the EPC determination component 914 may determine that the first and second EPCs are different.

When the EPC determination component 914 determines that the second EPC is different from the first EPC or that the second EPC is unassociated with a plurality of NHNs (e.g., the second EPC is dedicated to the second NHN 960), the EPC determination component 914 may provide an indication of the different or dedicated second EPC to a network attach component 908.

The network attach component 908 may perform a network procedure with the second NHN 960, e.g., because the apparatus 902 has no context in the second EPC and/or to set up at least one bearer for the apparatus 902. Accordingly, the network attach component 908 may generate a network attach request and provide the network attach request to the transmission component 910. The transmission component 910 may transmit the network attach request to the second NHN 960.

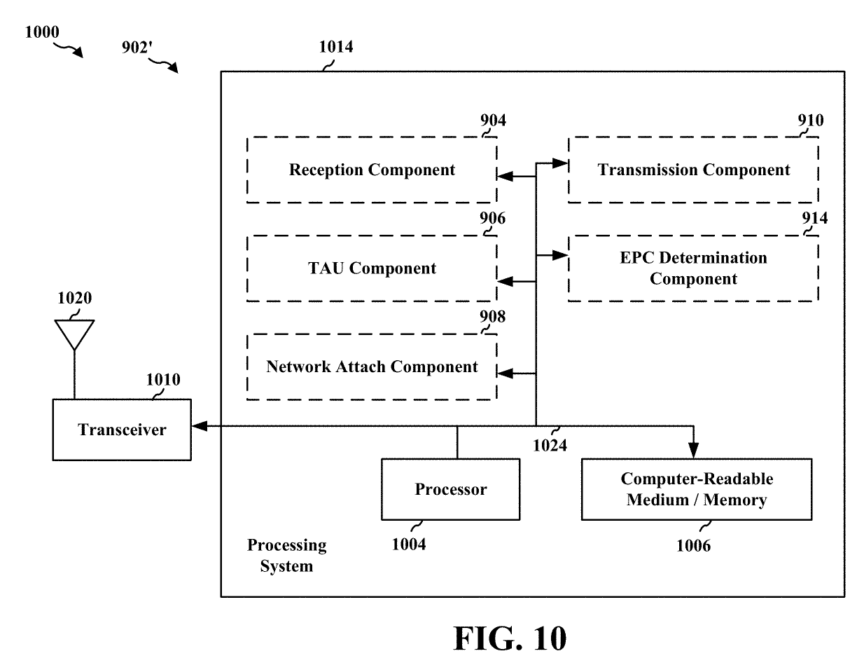

FIG. 10 is a diagram 1000 illustrating an example of a hardware implementation for an apparatus 902′ employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware components, represented by the processor 1004, the components 904, 906, 908, 910, 914 and the computer-readable medium/memory 1006. The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 is coupled to one or more antennas 1020. The transceiver 1010 provides a means for communicating with various other apparatus over a transmission medium. The transceiver 1010 receives a signal from the one or more antennas 1020, extracts information from the received signal, and provides the extracted information to the processing system 1014, specifically the reception component 904. In addition, the transceiver 1010 receives information from the processing system 1014, specifically the transmission component 910, and based on the received information, generates a signal to be applied to the one or more antennas 1020. The processing system 1014 includes a processor 1004 coupled to a computer-readable medium/memory 1006. The processor 1004 is responsible for general processing, including the execution of software stored on the computer-readable medium/memory 1006. The software, when executed by the processor 1004, causes the processing system 1014 to perform the various functions described supra for any particular apparatus. The computer-readable medium/memory 1006 may also be used for storing data that is manipulated by the processor 1004 when executing software. The processing system 1014 further includes at least one of the components 904, 906, 908, 910, 914. The components may be software components running in the processor 1004, resident/stored in the computer readable medium/memory 1006, one or more hardware components coupled to the processor 1004, or some combination thereof. The processing system 1014 may be a component of the UE 350 and may include the memory 360 and/or at least one of the TX processor 368, the RX processor 356, and the controller/processor 359.

In one configuration, the apparatus 902/902′ for wireless communication includes means for receiving, from a first network, a first identifier associated with a first NHN and an EPC, wherein the first identifier indicates whether the EPC is associated with a plurality of NHNs. The apparatus 902/902′ may further include means for determining, based on the first identifier, whether the EPC is associated with the plurality of NHNs, including the first NHN. In an aspect, the first identifier includes a first value when the EPC is associated with the plurality of NHNs, and wherein the first identifier includes a second value when the EPC is associated with the first NHN and unassociated with the plurality of NHNs. In an aspect, the first value or the second value is located in a first portion of the first identifier. In an aspect, when the first identifier includes the first value, EPC information associated with the EPC is located in a second portion of the identifier, and first NHN information associated with the first NHN is located in a third portion of the identifier. In an aspect, when the first identifier includes the second value, first NHN information associated with the first NHN occupies a remaining portion of the first identifier following the second value. In an aspect, the first identifier implicitly indicates whether the EPC is associated with the plurality of NHNs, including the first NHN, based on whether EPC information associated with the EPC is included in the first identifier. In an aspect, the first identifier implicitly indicates that the EPC is associated with the plurality of NHNs, including the first NHN, when the EPC information associated with the EPC is included in the first identifier.

The apparatus 902/902′ may further include means for receiving, from a second network, a second identifier including second NHN information associated with a second NHN. The apparatus 902/902′ may further include means for determining, based on the second identifier, whether the second NHN is associated with the EPC when the EPC is associated with the plurality of NHNs. The apparatus 902/902′ may further include means for performing a TAU procedure associated with the second NHN when the EPC is associated with the plurality of NHNs, including the first NHN and the second NHN. The apparatus 902/902′ may further include means for performing an attach procedure associated with the second NHN when the second NHN is unassociated with the EPC.

The aforementioned means may be one or more of the aforementioned components of the apparatus 902 and/or the processing system 1014 of the apparatus 902′ configured to perform the functions recited by the aforementioned means. As described supra, the processing system 1014 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof′ include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof′ may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication for a first neutral host network (NHN), the method comprising:
determining whether an evolved packet core (EPC) is associated with a plurality of NHNs, including the first NHN; and
transmitting an identifier, the identifier being associated with the first NHN and the EPC,
wherein the identifier indicates whether the EPC is associated with the plurality of NHNs, including the first NHN.

2. The method of claim 1, wherein the identifier includes a first value when the EPC is associated with the plurality of NHNs, and wherein the identifier includes a second value when the EPC is associated with the first NHN and unassociated with the plurality of NHNs.

3. The method of claim 2, wherein the first value is located in a first portion of the identifier.

4. The method of claim 3, wherein when the identifier includes the first value, EPC information associated with the EPC is located in a second portion of the identifier, and NHN information associated with the first NHN is located in a third portion of the identifier.

5. The method of claim 2, wherein when the identifier includes the second value, NHN information associated with the first NHN occupies a remaining portion of the identifier following the second value.

6. The method of claim 1, wherein the identifier implicitly indicates whether the EPC is associated with the plurality of NHNs based on whether EPC information associated with the EPC is included in the identifier.

7. The method of claim 6, wherein the identifier implicitly indicates that the EPC is associated with the plurality of NHNs, including the first NHN, when the EPC information associated with the EPC is included in the identifier.

8. A method of wireless communication for a user equipment (UE), the method comprising:
receiving, from a first network, a first identifier associated with a first neutral host network (NHN) and an evolved packet core (EPC), wherein the first identifier indicates whether the EPC is associated with a plurality of NHNs; and
determining, based on the first identifier, whether the EPC is associated with the plurality of NHNs, including the first NHN.

9. The method of claim 8, wherein the first identifier includes a first value when the EPC is associated with the plurality of NHNs, and wherein the first identifier includes a second value when the EPC is associated with the first NHN and unassociated with the plurality of NHNs.

10. The method of claim 9, wherein the first value or the second value is located in a first portion of the first identifier.

11. The method of claim 10, wherein when the first identifier includes the first value, EPC information associated with the EPC is located in a second portion of the identifier, and first NHN information associated with the first NHN is located in a third portion of the identifier.

12. The method of claim 10, wherein when the first identifier includes the second value, first NHN information associated with the first NHN occupies a remaining portion of the first identifier following the second value.

13. The method of claim 8, wherein the first identifier implicitly indicates whether the EPC is associated with the plurality of NHNs, including the first NHN, based on whether EPC information associated with the EPC is included in the first identifier.

14. The method of claim 13, wherein the first identifier implicitly indicates that the EPC is associated with the plurality of NHNs, including the first NHN, when the EPC information associated with the EPC is included in the first identifier.

15. The method of claim 8, further comprising:
receiving, from a second network, a second identifier including second NHN information associated with a second NHN; and
determining, based on the second identifier, whether the second NHN is associated with the EPC when the EPC is associated with the plurality of NHNs.

16. The method of claim 15, further comprising:
performing a tracking area update (TAU) procedure associated with the second NHN when the EPC is associated with the plurality of NHNs, including the first NHN and the second NHN.

17. The method of claim 15, further comprising:
performing an attach procedure associated with the second NHN when the second NHN is unassociated with the EPC.

18. An apparatus associated with a first neutral host network (NHN), the apparatus comprising:
means for determining whether an evolved packet core (EPC) is associated with a plurality of NHNs, including the first NHN; and
means for transmitting an identifier, the identifier being associated with the first NHN and the EPC,
wherein the identifier indicates whether the EPC is associated with the plurality of NHNs, including the first NHN.

19. The apparatus of claim 18, wherein the identifier includes a first value when the EPC is associated with the plurality of NHNs, and wherein the identifier includes a second value when the EPC is associated with the first NHN and unassociated with the plurality of NHNs.

20. The apparatus of claim 19, wherein the first value is located in a first portion of the identifier.

21. The apparatus of claim 20, wherein when the identifier includes the first value, EPC information associated with the EPC is located in a second portion of the identifier, and NHN information associated with the first NHN is located in a third portion of the identifier.

22. The apparatus of claim 19, wherein when the identifier includes the second value, NHN information associated with the first NHN occupies a remaining portion of the identifier following the second value.

23. An apparatus associated with a user equipment (UE), the apparatus comprising:
means for receiving, from a first network, a first identifier associated with a first neutral host network (NHN) and an evolved packet core (EPC), wherein the first identifier indicates whether the EPC is associated with a plurality of NHNs; and
means for determining, based on the first identifier, whether the EPC is associated with the plurality of NHNs, including the first NHN.

24. The apparatus of claim 23, wherein the first identifier includes a first value when the EPC is associated with the plurality of NHNs, and wherein the first identifier includes a second value when the EPC is associated with the first NHN and unassociated with the plurality of NHNs.

25. The apparatus of claim 24, wherein the first value or the second value is located in a first portion of the first identifier.

26. The apparatus of claim 25, wherein when the first identifier includes the first value, EPC information associated with the EPC is located in a second portion of the identifier, and first NHN information associated with the first NHN is located in a third portion of the identifier.

27. The apparatus of claim 25, wherein when the first identifier includes the second value, first NHN information associated with the first NHN occupies a remaining portion of the first identifier following the second value.

28. The apparatus of claim 23, further comprising:
means for receiving, from a second network, a second identifier including second NHN information associated with a second NHN; and
means for determining, based on the second identifier, whether the second NHN is associated with the EPC when the EPC is associated with the plurality of NHNs.

29. The apparatus of claim 28, further comprising:
means for performing a tracking area update (TAU) procedure associated with the second NHN when the EPC is associated with the plurality of NHNs, including the first NHN and the second NHN.

30. The apparatus of claim 28, further comprising:
means for performing an attach procedure associated with the second NHN when the second NHN is unassociated with the EPC.
